(19) United States
(12) Patent Application Publication
(10) Pub. No.: US 2015/0052788 A1
(43) Pub. Date: Feb. 26, 2015

(54) Personalized electronic greeting card

(71) Applicant: Eric M. Juetten, Brooklyn Park, MN (US)

(72) Inventor: Eric M. Juetten, Brooklyn Park, MN (US)

(21) Appl. No.: 14/121,337

(22) Filed: Aug. 21, 2014

Related U.S. Application Data
(60) Provisional application No. 61/959,384, filed on Aug. 22, 2013.

(51) Int. Cl. B42D 15/02; G06F 13/38; B42D 15/04

(52) U.S. Cl. CPC B42D 15/022; B42D 15/042; G06F 13/385
USPC 40/124.09

(57) ABSTRACT

One embodiment of the present invention describes a deformable greeting card comprising a thin foldable substrate in the shape and form of a greeting card amenable to folding along predetermined fold lines, the thin substrate with embedded integrated electronic components and electrical contacts, the electrical contacts in electrical communication with integrated electronic components and routed to one edge of the thin substrate, and termination of the electrical contacts compatible with insertion into computer USB ports when the greeting card is folded along the predetermined fold lines.

### CROSS REFERENCE TO RELATED APPLICATIONS

This application claims the benefit of United States Provisional Patent Application No. 61/959,384 filed Aug. 22, 2013, which hereby is incorporated herein in its entirety by reference thereto.

### FIELD OF THE INVENTION

The present invention is directed generally to electronic greeting cards, and more particularly to an electronic greeting card which can store personalized audio, video, or data information via the ability to directly interface the greeting card into standard computer USB ports.

### BACKGROUND

For many years paper greeting cards containing text sentiment and associated artwork have been widely used for celebratory occasions such as birthdays, graduations, weddings, and for other commercial purposes. Greeting cards have been made in conventional configurations such as two-panel foldable cards with a single fold line between two panels or multiple panels. More recently, greeting cards have been enhanced by incorporating light, sound, electronics or other special effects, although primarily in combination with conventional flat panel greeting cards.

Even in today's high tech society, people still gain enormous pleasure from receiving a personal greeting card, be it for a birthday, anniversary, etc. A visit into any greeting card retail outlet gives the purchaser the option of buying a variety of cards. However, the current state of the art in greeting cards does not allow the buyer to utilize the enormous amount of audio and video (e.g., family photos) they have stored on their personal computer at home or work, nor does the recipient of such a personal greeting card have the ability currently to download such data if it were somehow embedded in their received greeting card.

Given this, there is a need for an electronic greeting card that can be programmed by the purchaser with personalized information by direct communication with a personal computer—and likewise, the recipient can download and view/hear/archive the same information on their personal computer.

### SUMMARY OF THE INVENTION

Generally, the present invention is directed to electronic greeting cards, and more particularly to an electronic greeting card which can store personalized audio, video, or data information via the ability to directly interface the greeting card into standard computer USB ports.

One embodiment of the present invention describes a deformable greeting card comprising a thin foldable substrate in the shape and form of a greeting card amenable to folding along predetermined fold lines, the thin substrate with embedded integrated electronic components and electrical contacts, the electrical contacts in electrical communication with integrated electronic components and routed to one edge of the thin substrate, and termination of the electrical contacts compatible with insertion into computer USB ports when the greeting card is folded along the predetermined fold lines.

The above summary of the present invention is not intended to describe each illustrated embodiment or every implementation of the present invention.

The figures and the detailed description which follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 shows a schematic representation of one embodiment of the present invention depicting a greeting card shown open faced highlighting the fold lines to expose the electrical contacts for insertion into a computer USB port.

FIG. 2 shows the foldable region of the greeting card depicted in FIG. 1 highlighting the first step in folding the card along predetermined fold lines to ultimately expose the electrical contacts.

FIG. 3 shows the second step in the progression of folds to ultimately expose the electrical contacts.

FIG. 4 shows the final fold to sufficiently expose the electrical contacts for insertion into a computer USB port.

FIG. 5 shows the foldable greeting card with the exposed electrical contacts inserted into a computer USB port.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

In general, the present invention is directed to electronic greeting cards, and more particularly to an electronic greeting card which can store personalized audio, video, or data information via the ability to directly interface the greeting card into standard computer USB ports.

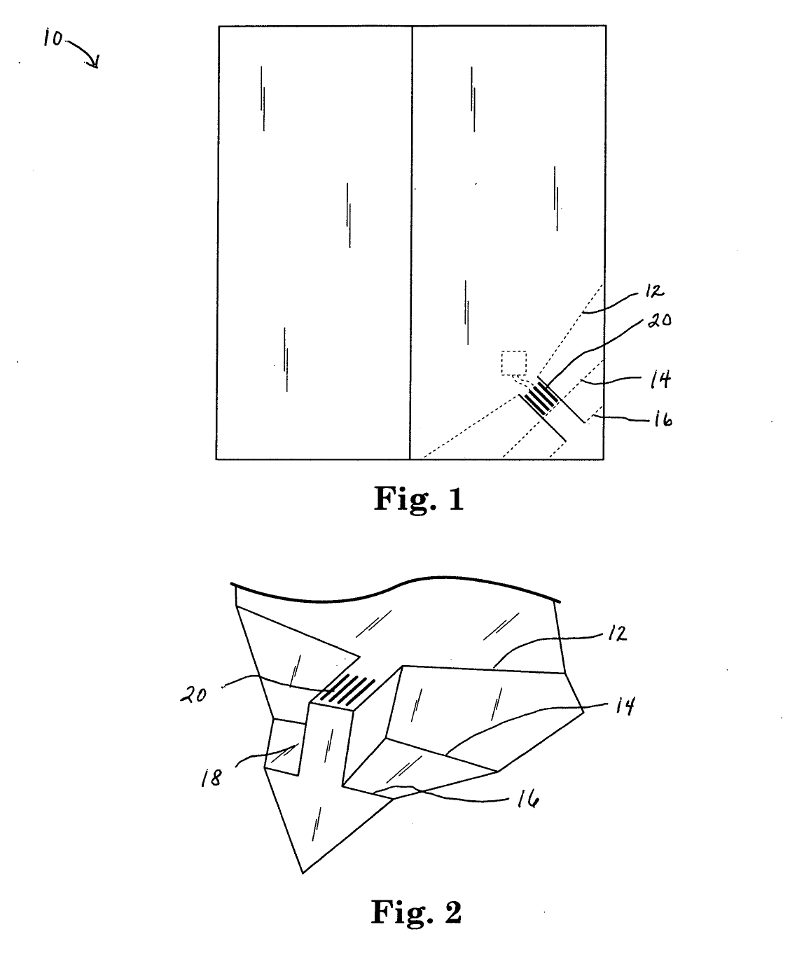

One embodiment of a personalized electronic greeting card 10 in accordance with the present invention is depicted schematically in FIG. 1.

FIG. 1 shows the greeting card 10 open faced highlighting the fold lines (12, 14, and 16) to expose the electrical contacts 20 for insertion into a computer USB port. The greeting card 10 may be manufactured from a thin paper-like material with sufficient mechanical integrity to be folded and returned to its original unfolded condition without noticeable cosmetic damage. Also, the foldable greeting card 10 may be sufficiently thick such that the onboard electronics may be imbedded there within and not visible by normal inspection.

FIG. 2 shows the first step in folding the greeting card along fold line 12. While beginning to fold along fold line 12, the greeting card 10 will simultaneously begin retrograding inward along fold lines 14, 16, and 18.

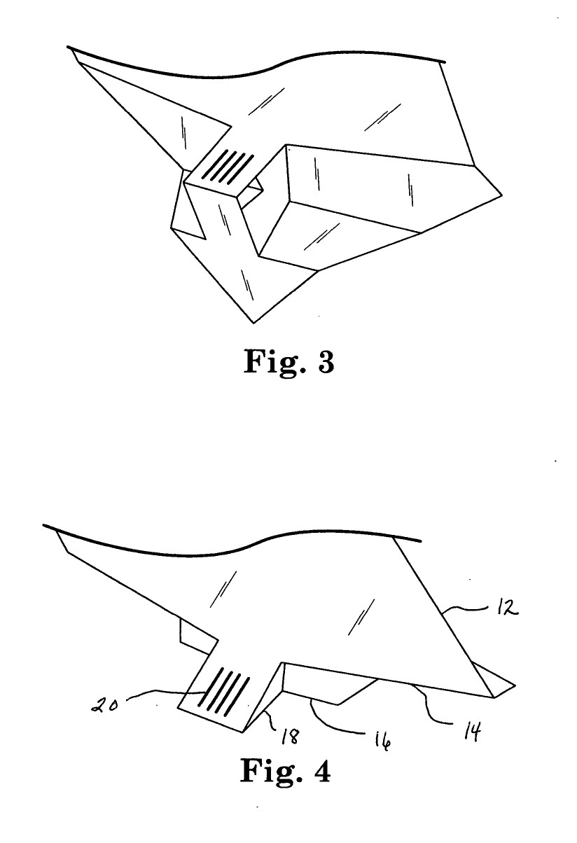

Eventually, the simultaneous folding along fold lines 12, 14, 16, and 18 the greeting card 10 will reach an intermediate half way point in folding progression as depicted in FIG. 3. FIG. 4 shows the final step of folding along fold lines 12, 14, 16, and 18 which ultimately exposes electrical contacts 20.

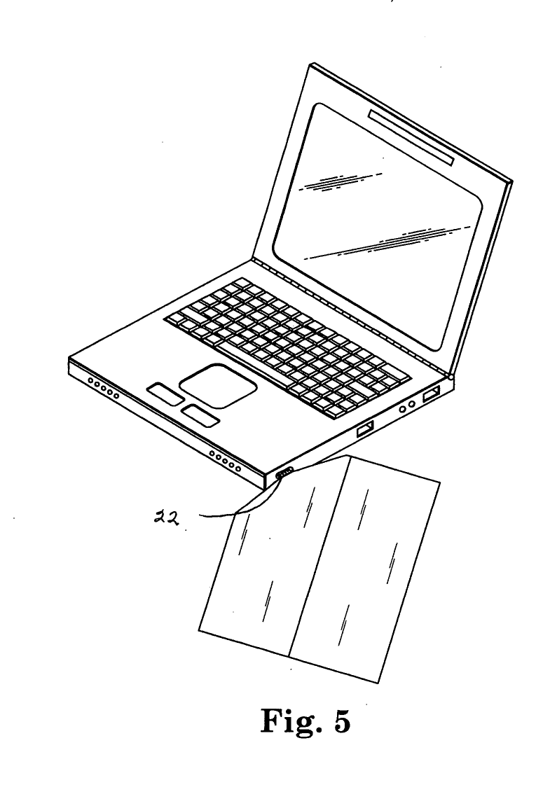

Now, with the electrical contacts 20 exposed as is shown in FIG. 4, the greeting card 10 may be interfaced in electrical communication with laptop or tower computers via the standard USB ports available therein. FIG. 5 shows such a configuration wherein the greeting card 10 depicted in FIG. 4, has been inserted into the USB port 22 of laptop computer 24.

Once the greeting card 10 has been inserted into the laptop's USB port 22 and is in electrical communication with the computer 24, a myriad of information can be transferred from the computer 24 to the on board memory chip 26 (shown in FIG. 1) embedded in the greeting card 10. For example, photos, audio information, videos, and the like can be stored on board the greeting card 10 making it a truly personalized greeting card.

The present invention should not be considered limited to the particular examples described above, but rather should be understood to cover all aspects of the invention as fairly set out in the attached claims. Various modifications to the shape and form factors described above, equivalent processes as well as numerous structures to which the present invention may be applicable will be readily apparent to those of skill in the art to which the present invention is directed upon review of the present specification. The following claims are intended to cover such modifications and devices.

I claim:

1. A deformable greeting card comprising:
a thin foldable substrate in the shape and form of a greeting card amenable to folding along predetermined fold lines;
said thin substrate with embedded integrated electronic components and electrical contacts;
said electrical contacts in electrical communication with integrated electronic components and routed to one edge of the thin substrate; and
termination of said electrical contacts compatible with insertion into computer USB ports when the greeting card is folded along said predetermined fold lines.

2. The device of claim 1 wherein the foldable nature along the predetermined fold lines of the greeting card is reversible.

3. The device of claim 1 wherein the integrated electronic components and the electrical contacts are embedded within the substrate.
